(19) United States
(12) Patent Application Publication
(10) Pub. No.: US 2004/0124647 A1
(43) Pub. Date: Jul. 1, 2004

(54) Container with pneumatically driven locking mechanisms

(76) Inventors: Stephan Hase, Dusseldorf (DE); Goetz Coenen, Meerbusch (DE)

Correspondence Address: Robert W Becker & Associates, Suite B, 707 Highway 66 East, Tijeras, NM, 87059, US

(21) Appl. No.: 10/470,503

(22) PCT Filed: Jan. 28, 2002
(86) PCT No.: PCT/DE02/00283

(30) Foreign Application Priority Data
Jan. 29, 2001 (DE) 10104067.9

(51) Int. Cl. B66C 1/66

(52) U.S. Cl. 294/81.53; 220/1.5

(57) ABSTRACT

The invention relates to a container with a pneumatically driven locking mechanism and more specifically a container. One disadvantage of conventional containers is that when they are stacked on top of each other, it is not possible to raise and transport several of such containers at the same time. Another disadvantage is that stacked containers have hitherto needed to be locked manually, resulting in a considerable safety risk for dock workers and ship workers. The aim of the invention is to provide a container which is fitted in such a way that it can be locked with other similar containers without the need for manual activity and enable several stacked containers to be transported simultaneously. This is achieved by providing the container with corners having pneumatically driven, rotatable and displaceable locking devices arranged therein. The lower ends thereof have locking elements which engage with corresponding hollow bodies which are arranged in upper corner areas in order to receive the locking devices and which can lock the containers with each other. A control unit and a signalling element for detecting the exact position of the locking mechanism are also provided.

### DESCRIPTION OF THE INVENTION

The invention relates to containers with pneumatically driven locking mechanisms, and in particular to shipping containers. It is, however, applicable to all containers in the same manner, irrespective of size and shape, on the outer walls of which hollow bodies are provided for the accommodation of locking devices. The invention is explained hereinafter in greater detail by way of the example of a shipping container.

The transport of freight goods is effected nowadays worldwide preponderantly by the use of standardised containers. The containers are deposited at the loading location, loaded there, and then loaded onto a vehicle (road or rail vehicle), if appropriate conveyed to a harbour or airport, there loaded onto a ship or aircraft, and therefore interlocked and lashed together with other containers in order to provide secure transport, unlocked and released from lashings again at the place of arrival, and loaded onto a vehicle, brought to the destination location, and offloaded there. Transport logistics demand a method of loading and unloading such containers which is both safe and rapid, whereby the technology being applied must be capable of accommodating, transporting, or interlocking containers of different dimensions. Containers exhibit in their upper and lower corner areas in each case hollow bodies (referred to as “corner castings”), which are provided with oval openings on their sides which face outwards. Looking devices from depositing equipment (container spreaders) or overhead handling equipment can be introduced into theme oval openings, whereby these locking devices exhibit end areas (twistlocks) of which the dimensions are smaller than the oval openings in the hollow bodies. As soon as the twistlocks have been introduced into the hollow bodies, they are mechanically rotated, so that the container is locked to the container spreader or the overhead handling equipment and can be transported. When raising, the upper side of the twistlock comes into contact with the underside of the cover well of the hollow body.

Container spreaders are known which can simultaneously accommodate and move two 20′ containers standing one behind the other (there are standardised 20′ containers, 40′ containers, and 45′ containers) . The advantage of such container spreaders is limited, however, since on the one hand only the smaller containers (20 feet) can be accommodates, while on the other two such containers must stand one behind the other and the possibility of use only pertains in situations in which there, is sufficient deposition space. The situation becomes particularly problematic if several container stacked on top of on another must be interlocked, such as is necessary in particular with ships' loads or in container terminals. In this case, interlocking takes place manually, in that two containers arranged on top of one another or next to on another are locked to one another manually by means a connection and locking elements (locking grips or bars). This is time-consuming and, because of the risk of injury when applying the connecting and locking elements, also dangerous.

The object of the present invention is to provide a container which is equipped in such a way that it can be interlocked vertically with other containers of the same type without manual intervention, and several containers stacked on top of one another can be transported simultaneously.

This object is achieved with the features of patent claim 1.

The corners of the container exhibit pneumatically driven, rotatable, and displaceable locking mechanisms. If it is intended that two containers should be stacked on top of or beneath one another, the one container is placed on the other container in such a way that the lower hollow bodies of the upper container are flush with the upper hollow bodies of the lower container. Because the locking mechanisms in the corners of the upper container are displaceable, they can be pressed downwards by the pneumatic drive and engage in the upper hollow bodies of the lower container. In this state, a rotation of the locking mechanisms can take place, so that the containers can be locked to one another and, if required, raised and transported simultaneously. With the invention it is possible, without manual intervention, to carry out a continuous vertical interlocking of as many containers as may be desired above or beneath one another. As a result, during the loading or unloading of ships, several containers stacked beneath one another can be lifted and moved simultaneously, with the result that loading and unloading time is substantially reduced. As a result of this, not only will berthage charges in ports be reduced, but demurrage tines will be substantially shortened and available voyage times of vessels increased, as a result of which faster transport of the containers from port to port will become possible. The profitability of the vessel will at the same time be optimised. A further substantial advantage of the invention lies in the fact that the manual locking and lashing which was customary hitherto can be done away with, and therefore the risk of injury of the workers in the port or on the vessel can be minimised. Additional substantial costs savings will be obtained as a result.

According to a preferred embodiment, the container exhibits a frame structure design of which at least one frame part has at least one water-tight closable opening. The purpose of this opening is that the locking mechanism secured in the corner which is designed as a hollow body, which according to a further preferred embodiment is designed as a module, can be taken out of the corner and reinserted. In this way, defective parts can be immediately replaced and long repair times avoided. The container will constantly be kept ready for use, If, according to a further embodiment, the hollow bodies are connected to their adjacent frame parts in a releasable manner, openings in the frame parts can be used to connect the frame parts to the adjacent hollow bodies from the inside. Inasmuch as parts of the device according to the invention are located in the frame parts, access to these parts in guaranteed, so that both construction as well as maintenance are possible without any problem.

According to a further advantageous embodiment, the container exhibits means of accepting and forwarding electrical energy. In this way, the supply of electric current to the container can be guaranteed. This is particularly necessary for the operation of a control unit, which is provided for according to a further advantageous embodiment. This control unit controls the introduction of compressed air into the looking mechanism and the onward conveyance of compressed air to a discharge location in the area of the lower hollow body for accommodating interlocking devices of the container corners, by means of which compressed air can be passed on into the next container. In addition, the control unit accepts the signals which, according to a further preferred embodiment, are transmitted to it by the signal generator, which is in contact with sensors. The intention of these signals is to indicate to the crane driver the position in which the locking mechanism is located. To advantage, the pneumatically driven looking mechanism consists of a cylinder, in the wall of which a longitudinal cut-out is located, which has approximately the appearance of a V rotated through 90°. A bolt engages into this cut-out, which is secured to the locking bar. This link drive arrangement allows for a rotation of the locking mechanism, and therefore the locking of the containers to one another. It is likewise of advantage if the cylinder has an engagement nose on its lower end, which can engage in engagement grooves which are located on the locking bar. As a result of this, the cylinder can control the upwards and downwards movement of the locking bar section by section.

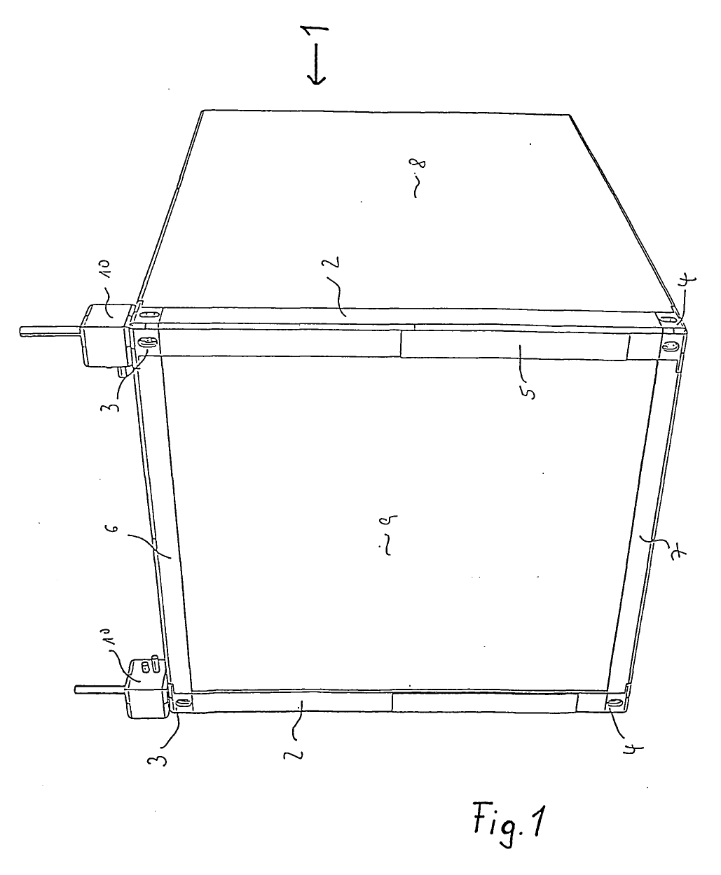

The invention is described hereinafter in greater detail on the basis of FIG. 1 to 5.

The Figures show:

FIG. 1: A part view of a container, which is locked to a container spreader;

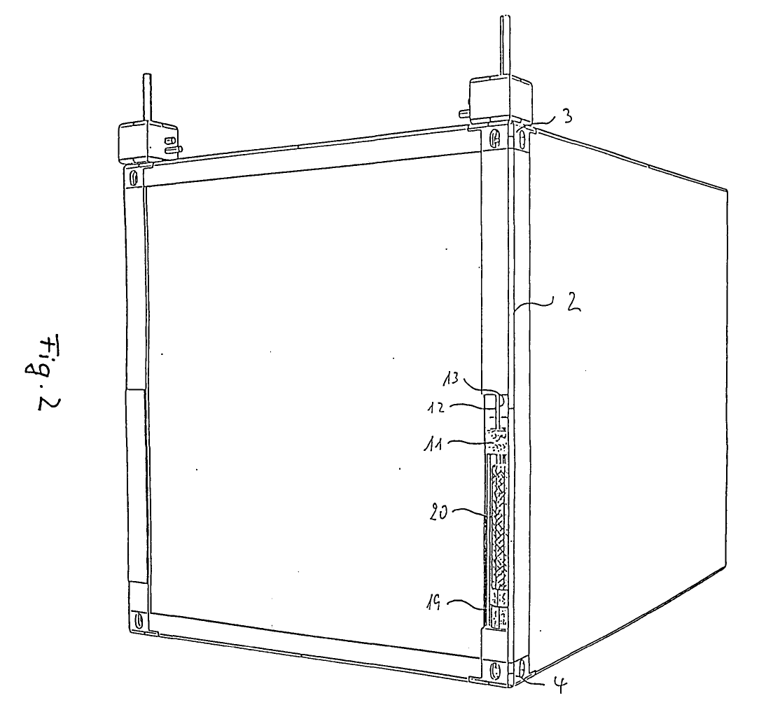

FIG. 2: An opened corner of a container according to FIG. 1;

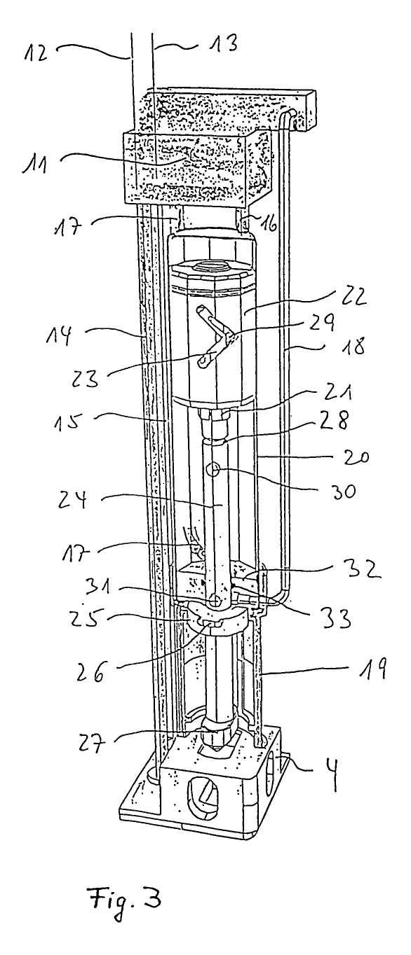

FIG. 3: The technical equipment of a container corner;

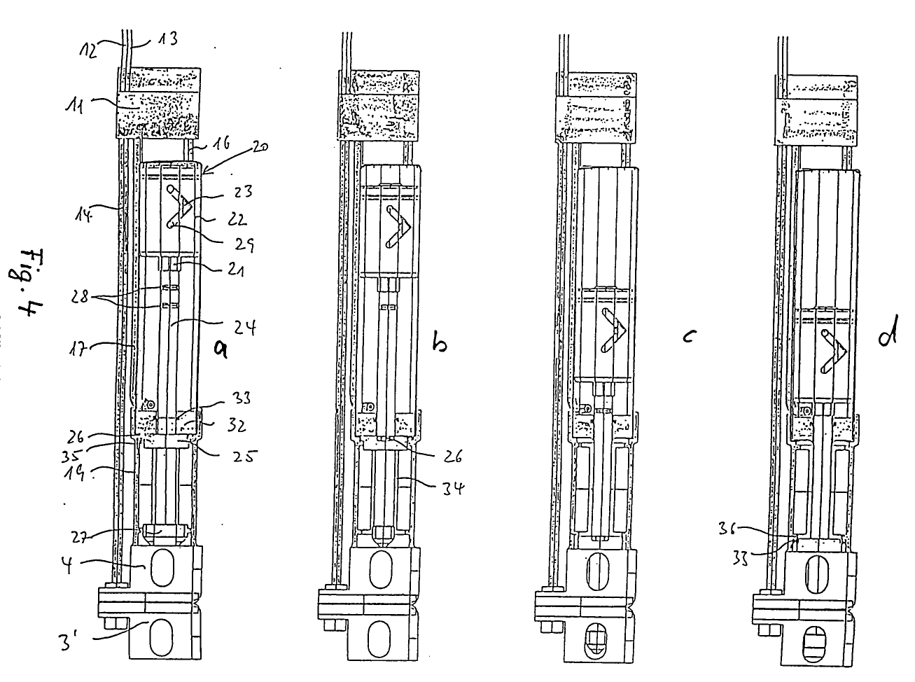

FIGS. 4a to 4d: The movement sequence during the interlocking of a container with another container;

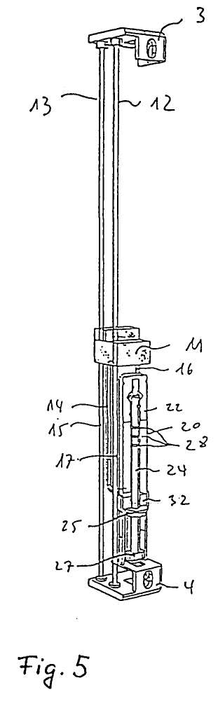

FIG. 5: A sectioned corner of a container.

FIG. 1 represents a container (1) in a part view. It exhibits a corner (2), on the upper end of which is located a locking housing (3), referred to hereinafter as a casting, and on the lower end of which a casting (4) is located. The container corners (2) are hollow on the inside and exhibit closure elements (5) in their lower area. This closure element is represented, for the purposes or the representation in FIGS. 1 and 2, as lying on the outside of the container corner. Expediently, the closure element is, however, located on the inside of the container and is guided over the corner, so that good accessibility is provided into the interior of the container corner. Thanks to this positioning, the interior of the container corner is protected against dirt and water. The closure element is bolted to the corner of the container by means of a water-tight seal, not represented here in any greater detail.

The upper castings are connected to one another by means of upper transverse frames (6), and the lower castings to one another by means of lower transverse frames (7). Upper and lower transverse frames can also be located on the longitudinal side of the container, which are not represented here in any greater detail. Further identifiable in FIG. 1 are side walls (8, 9). Here also, two carrier arms (10) are represented, of a container spreader not otherwise represented in any greater detail. Located on the lower end of the carrier arms, likewise not represented, are twistlocks, with which the container spreader is locked to the containers. FIG. 2 shows a container corner (2), in which the closure element (5) has been removed. Identifiable are a compressed air line (12) and a line (13) in which are located a power cable and a connection cable, as well as a control unit (11) and a cylindrical housing (20), which is partially located in a housing (19). FIG. 3 represents the technical equipment of a container corner. The control unit (11) is connected to a compressed air feed line (12) and a line (13). Located in the control unit (11) is a 4/3 directional valve, which regulates the forwarding of the compressed air into the lines (14, 16, 17). In addition, the control unit (11) exhibits an electronic control unit, by means of which the current feed is regulated into a cable, which is conducted in the line (15), and which conveys, processes, and forwards information from the signal generator (32) via the connection cable (18). Located in the line (15) is also a cable, by means of which information is forwarded into the control unit (11′) of a further container located beneath the first container and interlocked to it, and from the control unit (11′) is transferred into the control unit (11). A cylindrical housing (20) is located in the interior of the container corner, and is located with its lower end fitting precisely in a housing (19), which is securely connected to the casting (4). A tilted cylinder (22) is arranged in the housing (20), which is axially displaceable but not rotatable, and is guided from the inner wall of the housing (20). The cylinder (22) exhibits a link drive arrangement (23), through which a bolt (29) projects. The bolt (29) in connected securely to a locking bar (24). The locking bar (24) exhibits engagement grooves (28), into which an engagement nose (21) of the cylinder (22) can engage. In addition to this, sensors (30, 31) are located on the upper side of the interlocking bars (24) at defined distances from one another, which can be acquired by a signal generator (32). The signals are forwarded to the control unit (11) via the connection cable (18). Located in the lower area of the interlocking bar (24) is a support bearing (25) with guide noses (26). Arranged at the lower end of the interlocking bar (24) is an interlocking element (27), referred to as a twistlock.

FIGS. 4a to 4d show the functional method of the invention. When the casting (4) of the upper container cares in contact onto the casting (3′) of the container located beneath, a signal pin, not represented in any greater detail, is pressed into the interior of the casting (4), and transfers a signal via a connection cable in the line (15) to the control unit (11). From there, the signal is transferred via a connection cable in the line (13) to the container spreader, and from there to the crane driver's cab. The crane driver now knows that the two containers are standing on top of one another, and that the interlocking process can begin. By means of a compressor on the container spreader, compressed air is conveyed in lines in the carrier arms (10) of the container spreader into the line (12), and from there into the control unit (11). At that point, the 4/3-directional valve clears the passage into the lines (14) and (16), while the line (17) is opened to the atmosphere. In the line (14), the compressed air can only pans as far as a value on the casting (4), but is not yet introduced into the line (12′) of the container located beneath. Compressed air is imposed on the line (16), and presses the cylinder (22) downwards. The interlocking bar (24), in the upper engagement groove (28) the engagement nose (21) of the cylinder (22) engages, is prevented from an axial movement downwards, in that the guide nose (26) of the bearing (25) is held by a securing part (35) and the interlocking element (27) is positioned transverse to the upper longitudinal opening of the casting (4). As a result, in the event of a downwards movement of the cylinder (22), the bolt (29) at the interlocking bar (24) is guided in the link drive arrangement (23) and reaches a middle position, which is shown in FIG. 4b. As a result of this the locking bar (24) is rotated through 90 degrees, and the engagement nose (21) of the cylinder (22) is conducted onwards from the upper engagement groove into the middle engagement groove, as can likewise be seen from FIG. 4b. At the same time, due to the rotation of the interlocking bar (24), the guide nose (26) of the bearing (25) is turned away from the securing part (35), and the interlocking element (27) is located in a precise fit at the upper longitudinal opening of the casting (4). The interlocking bar (24) can now move downwards. This is shown in FIG. 4c. The compressed air conducted through the line (16) presses the cylinder (22) downwards, and now with it also the interlocking bar (24). In this situation, the guide nose (26) of the bearing (25) is guided in the guide groove (34) and prevents a rotation of the interlocking bar (24). The air in the apace beneath the cylinder (22) is pressed out through the line (17) and conducted away into the atmosphere. In FIG. 4c the interlocking element (27) has reached its lower position, i.e. it is located in the casting (3′) of the lower container. The compressed air forces the cylinder (22) to move further downwards, which the interlocking bar (24) cannot do, because the bearing (25) is in contact on the casting (4). The bolt (29) moves from the middle position in the link drive arrangement (23) into the upper position, and causes a further rotation of the interlocking bar (24) through 90 degrees, as a result of which, on the one hand, the interlocking element (27) is locked in the casting (3′) of the lower container, and, on the other, the guide nose (26) is guided beneath the securing part (36) and is therefore secured. The engagement nose (21) now engages in the lower engagement groove (28). If the interlocking bar (24) is located in the position according to FIG. 4a, then a contact pertains (see FIG. 3) between the sensor (31) and the signal generator (32), so that the crane driver knows that the interlocking element (27) is located in the secured position of rest. If the interlocking bar (24) is rotated through 90 degrees (FIG. 4b), this contact will be interrupted. This too will be indicated In the signal generator by corresponding displays. If the interlocking bar (24) is located in the position according to FIG. 4c, the sensor (30) is located in the area of the signal generator (32). This is displayed. If the position of the interlocking bar (24) according to FIG. 4d is reached, a contact pertains between the sensor (30) and the signal generator (32), so that the crane driver knows that the upper container is interlocked with the lower container.

Once the interlocking process has been concluded, a securing magnet on the casting (4) is deactivated by a signal from the control element (11), so that compressed air can now flow through the compressed air line (14) into the lower container. In this way, the lower container can now be interlocked with the next container located beneath it.

Unlocking takes place in precisely the reverse manner, i.e. from FIG. 4d to FIG. 4a.

FIG. 5 represents the technical configuration between the upper casting (3) and the lower casting (4) of a container corner according to the foregoing description.

### List of Reference Figures

1=Container

2=Corner

3=Casting top

4=Casting bottom

5=Closure element

6=Upper transverse frame

7=Lower transverse frame

8=Longitudinal side

9=Transverse side

10=Carrier arm of container spreader

11=Control unit

12=Compressed air feed line

13=Cable

14=Compressed air line

15=Cable

16=Compressed air line, top

17=Compressed air line, bottom

18=Connection cable

19=Housing

20=Cylinder

21=Engagement nose

22=Piston

23=Link drive arrangement

24=Interlocking bar

25=Bearing

26=Guide nose

27=Interlocking element

28=Engagement grooves

29=Bolts

30=Sensor

31=Sensor

32=Signal generator

33=Seals

34=Guide groove

35=Securing part

36=Securing part

1. Container, on the outer corner areas of which hollow bodies are provided for accommodating locking devices, characterised in that the container exhibits corners in which a pneumatically driven rotatable and displaceable locking mechanism is arranged, on the under part of which a locking element is located, which engages in corresponding hollow bodies of a container of the same type located beneath, arranged at the upper corner areas in order to accommodate locking devices, and is capable of locking the containers to one another, and that the containers can be interlocked with one another.

2. Container according to claim 1, characterised in that the container exhibits a frame structure, of which at least a part of the frame possesses at least one water-tight closable opening.

3. Container according to claim 2, characterised in that the locking mechanism is arranged in a housing which can be removed from the container corner in the manner of a module.

4. Container according to one of claims 1 to 3, characterised in that the hollow bodies are connected in a releasable manner to the frame parts adjacent to them.

5. Container according to one of claims 1 to 4, characterised in that the container exhibits means which can accept and convey electrical energy.

6. Container according to one of claims 1 to 5, characterised in that the container exhibits means for the acceptance and conveying of compressed air into the locking mechanism and into an emission source for a further container.

7. Container according to one of claims 1 to 6, characterised in that the container exhibits sensors and signal generators which display the position in each case of the interlocking mechanism in the container corner.

8. Container according to one of claims 1 to 7, characterised in that the container exhibits a control unit, which regulates the imposition of compressed air on the container as well as controlling the compressed air in an adjacent container, and accepts, processes, and forwards the signals from sensors.

9. Container according to one of claims 1 to 8, characterised in that the pneumatic drive exhibits a cylinder, in the wall of which a longitudinal cut-out is located, which has the approximate appearance of V rotated through 90° and into which a bolt located on the looking bar engages.

10. Container according to claim 9, characterised in that the cylinder exhibits an engagement nose on its lower end.

11. Container according to claim 9, characterised in that the locking bar exhibits engagement slots, into which the engagement nose of the cylinder can engage.

12. Container according to one of claims 1 to 11, characterised in that means are provided in the area of the upper and lower hollow bodies for accommodating locking devices, for the acceptance and conveying of compressed air, electric current, and electronic information.
